(19) United States
(12) Patent Application Publication
(10) Pub. No.: US 2019/0126921 A1
(43) Pub. Date: May 2, 2019

(54) COMPUTER-ASSISTED OR AUTONOMOUS DRIVING METHOD AND APPARATUS WITH CONSIDERATION FOR TRAVELERS' INTENT

(71) Applicant: Intel Corporation, Santa Clara, CA (US)

(72) Inventors: Paul Gwin, Orangevale, CA (US); Mark Sprenger, Tigard, OR (US)

(21) Appl. No.: 16/228,515

(22) Filed: Dec. 20, 2018

(51) Int. Cl. B60W 30/095; G05D 1/00; B60W 40/09; G06K 9/00

(52) U.S. Cl. CPC B60W 30/0956; G05D 1/0088; G05D 2201/0213; G06K 9/00805; B60W 2550/10; B60W 40/09

(57) ABSTRACT

Apparatuses, storage media and methods associated with computer assisted or autonomous driving (CA/AD), are disclosed herein. In some embodiments, an apparatus includes one or more communication interfaces to receive an intended or projected path of an object proximally moving near the CA/AD vehicle; sensors to collect sensor data associated with stationary or moving objects in a surrounding area of the CA/AD vehicle; and a navigation subsystem to navigate or assist in navigating the CA/AD vehicle to a destination, based at least in part on the sensor data associated with the stationary or moving objects in the surrounding area, and the received intended or projected path of the object proximally moving near the CA/AD vehicle. Other embodiments are also described and claimed.

### TECHNICAL FIELD

The present disclosure relates to the field of computer-assisted or autonomous driving (CA/AD). More particularly, the present disclosure relates to method and apparatus for CA/AD with consideration for travelers' intent.

### BACKGROUND

With advances in integrated circuits, sensors, computing and related technologies, increasingly, more and more operations of a vehicle receive computer assistance, from parallel parking, to lane changing, and so forth. Fully autonomous driving vehicles are expected to be generally available to average consumers very soon. It is relatively difficult for CA/AD vehicles to understand the intentions of people (e.g., pedestrians), such as their next move—whether they will go straight, turn left, turn right, go back, start to run, or walk. This can produce latency in the decision making schemes of CA/AD vehicles. They have to make sense of passive or ambiguous information and unfortunately, if the CA/AD vehicle makes a wrong decision, disastrous results may ensue.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates an overview of an environment for incorporating and using the CA/AD driving technology of the present disclosure that factors into consideration travelers' intent, in accordance with various embodiments.

FIG. 2 illustrates an example application of the CA/AD technology with consideration of travelers' intent of the present disclosure, according to various embodiments.

FIG. 3 illustrates the inference or projection of intended or projected path in further details, according to various embodiments.

FIG. 4 illustrates an example process of CA/AD with consideration of a traveler's intent of the present disclosure, according to various embodiments.

FIG. 5 illustrates an example process of a personal system of a traveler, according to various embodiments.

FIG. 6 illustrates an example process of a route logging and prediction cloud service, according to various embodiments.

FIG. 7 illustrates an example process of a navigation subsystem of a CA/AD vehicle, according to various embodiments.

FIG. 8 illustrates a component view of an example personal system of a traveler, according to various embodiments.

FIG. 9 illustrates an example neural network suitable for use by a navigation subsystem of a CA/AD vehicle, according to various embodiments;

FIG. 10 illustrates a software component view of an in-vehicle system, according to various embodiments.

FIG. 11 illustrates a hardware component view of a computer platform, suitable for use as an in-vehicle system or a cloud server, according to various embodiments.

FIG. 12 illustrates a storage medium having instructions for practicing methods described with references to FIGS. 1-8, according to various embodiments.

### DETAILED DESCRIPTION

To address challenges discussed in the background section, apparatuses, storage media, and methods for computer-assisted or autonomous driving that factors into consideration object intent, are disclosed herein. In some embodiments, an apparatus for CA/AD includes one or more communication interfaces, disposed in a CA/AD vehicle, to receive an intended or projected path of a traveler proximally traveling near the CA/AD vehicle, and sensors, disposed in the CA/AD vehicle, to collect sensor data associated with stationary or moving objects in a surrounding area of the CA/AD vehicle, including the traveler proximally traveling near the CA/AD vehicle. Additionally, the CA/AD vehicle further includes a navigation subsystem, disposed in the CA/AD vehicle and coupled with the one or more communication interfaces and the sensors, to navigate or assist in navigating the CA/AD vehicle to a destination, based at least in part on the sensor data associated with the stationary or moving objects in the surrounding area, and the received intended or projected path of the traveler proximally traveling near the CA/AD vehicle. The traveler may, for example, be a pedestrian or a bicyclist.

In various embodiments, the technology further includes an apparatus for a traveler, comprising: sensors to collect sensor data associated with routes or paths traveled by the traveler, while carrying or wearing the apparatus; and one or more communication interfaces to provide an intended or projected path of the traveler to a vehicle proximately moving near the traveler, the intended or projected path being inferred or projected based at least in part on the sensor data collected for routes or paths previously traveled by the traveler.

In various embodiments, the technology further includes at least one computer-readable medium (CRM) having instructions stored therein, to cause a computing device, in response to execution of the instruction by the computing device, to: receive, from a personal system of a pedestrian or a bicyclist, sensor data collected by sensors of the personal system for routes or paths traveled by the pedestrian or bicyclist; store the received sensor data collected for routes or paths traveled by the pedestrian or bicyclist; generate a current intended or projected path of the pedestrian or bicyclist, based at least in part on the stored sensor data for routes or paths previously traveled by the pedestrian or bicyclist; and output the generated current intended or projected path of the pedestrian or bicyclist to assist a computer assisted or autonomous driving (CA/AD) vehicle in responding to detection of the pedestrian or bicyclist proximally moving near the CA/AD vehicle.

In various embodiments, the technology further includes a method for computer assisted or autonomous driving (CA/AD), comprising: assisting or autonomously navigating a vehicle to a destination; detecting a traveler proximally moving near the vehicle; determining a response to the detection of the traveler proximally traveling near the vehicle, based at least in part on a received intended or projected path of the traveler.

In the following detailed description, these and other aspects of the CA/AD with consideration for travelers' intent technology will be further described. References will be made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternate embodiments of the present disclosure and their equivalents may be devised without parting from the spirit or scope of the present disclosure. It should be noted that like elements disclosed below are indicated by like reference numbers in the drawings.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “In some embodiments,” which may each refer to one or more of the same or different embodiments. Furthermore, the terms “comprising,” “including,” “having,” and the like, as used with respect to embodiments of the present disclosure, are synonymous.

As used herein, the term “module” or “engine” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

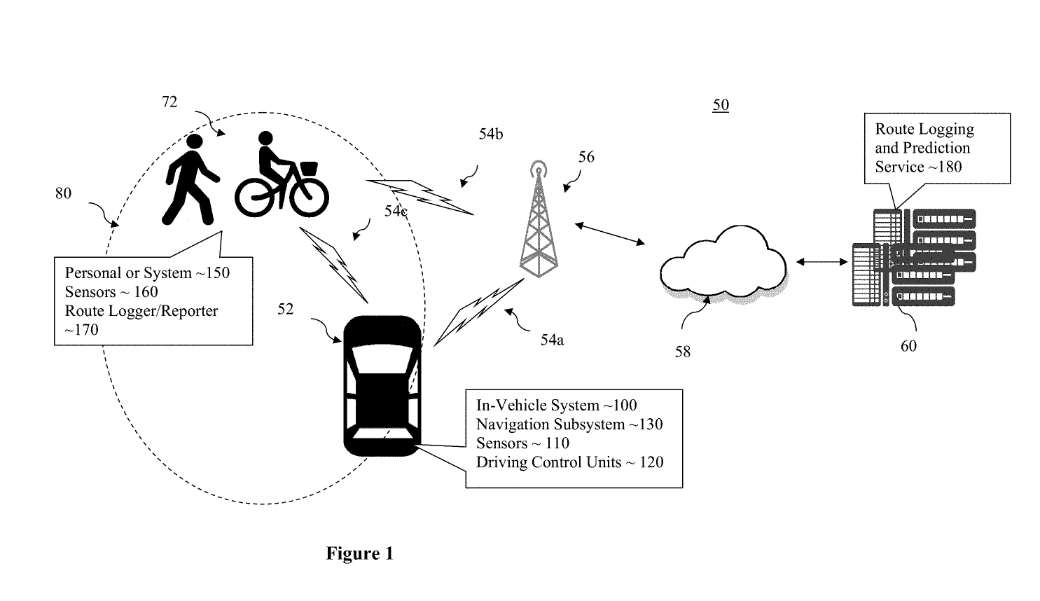

Referring now to FIG. 1, wherein an overview of an environment for incorporating and using the CA/AD with consideration of travelers' intent technology of the present disclosure, in accordance with various embodiments, is illustrated. As shown, for the illustrated embodiments, example environment 50 includes moving vehicle 52 and traveler (also referred to as moving object) 72 proximally traveling (moving) near vehicle 52. Example of traveler (or moving object) 72 may include, but are not limited to a pedestrian, a bicyclist or a robot.

Traveler (or moving object) 72 wears, carries or otherwise has personal system 150 with it as it travels on trips. Personal system 150 is arranged to log and report the routes or paths object 72 travels for various trips between various starting locations and destination locations. These logged routes or paths of various trips previously traveled by traveler (or moving object) 72 are used to generate a current intended or projected path for a particular point in time and location of a current trip. Thus, when traveler (or moving object) 72 proximally travels (or moves) near vehicle 52, the current intended or projected path of traveler (or moving object) 72 at the particular time and location can be provided to vehicle 52 to take into consideration in determining its response to the detection of the proximally traveling/moving person/object 72. Resultantly, vehicle 52 can make a more informed and potentially safer decision.

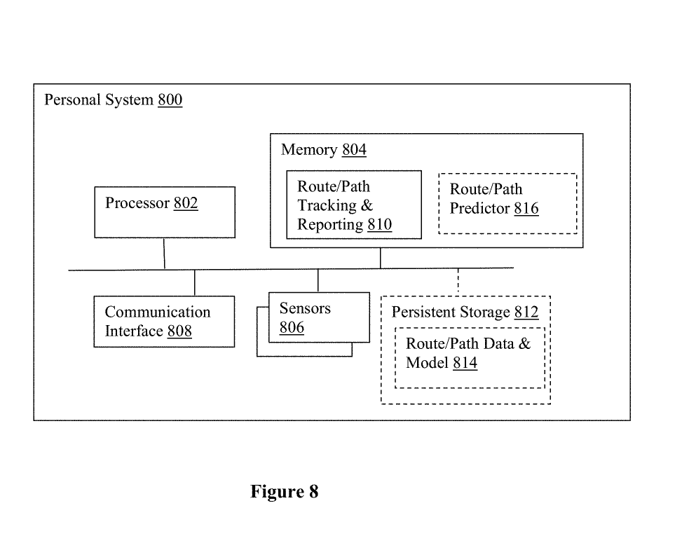

For the illustrated embodiments, personal system 150 includes one or more sensors 160 and route logger/reporter 170. Sensors 160 include in particular a sensor configured to collect sensor data associated with a current location of the personal system 150. Example of such sensor may include, but are not limited to a global positioning sensor. Route logger/reporter 170 is configured to log the collected sensor data associated with the locations of personal system 150, which corresponds to the locations of the various routes/paths traveled by traveler (or moving object) 72, when traveler (or moving object) 72 travels with personal system 150 (i.e., carrying, wearing or otherwise has personal system 150 with traveler (or moving object) 72). Except for the technology of the present disclosure incorporated with personal system 150, personal system 150 may be any one of a number of portable or wearable devices, such as, mobile phones, smart watches, and so forth, known in the art. An example personal system 150 will be described in more detail below with references to FIG. 8.

Vehicle 52 includes an engine, transmission, axles, wheels and so forth (not shown). Further, vehicle 52 includes in-vehicle system (IVS) 100, sensors 110 and driving control units (DCU) 120. IVS 100 includes navigation subsystem 130. Navigation subsystem 130 is configured to provide navigation guidance or control, depending on whether CA/AD vehicle 52 is a computer-assisted vehicle, partially or fully autonomous driving vehicle. Navigation subsystem 130 is configured with computer vision to recognize stationary or moving objects (such as traveler or moving object 72) in an area 80 surrounding CA/AD vehicle 52, as it travels enroute to its destination. In various embodiments, navigation subsystem 130 is configured to recognize stationary or moving objects (such as traveler or moving object 72) in area 80 surrounding CA/AD vehicle 52, and in response, make its decision in guiding or controlling DCUs of CA/AD vehicle 52, based at least in part on sensor data collected by sensors 110. However, as described earlier, for the illustrated embodiments, navigation subsystem 130 is endowed with the technology of the present disclosure, further taking into consideration the current intended or projected path of traveler (or moving object) 72 when determining its response to the detection of traveler or (or moving object) 72 proximally traveling/moving near vehicle 52. The size of surrounding area 80 may vary from application to application, depending on the sensing capability or range of the sensors included with CA/AD vehicle 52.

Sensors 110 include in particular one or more cameras (not shown) to capture images of surrounding area 80 of CA/AD vehicles 52. In various embodiments, sensors 110 may also include light detection and ranging (LiDAR) sensors, accelerometers, gyroscopes, global positioning system (GPS) circuitry, and so forth. Examples of driving control units (DCU) may include control units for controlling engine, transmission, brakes of CA/AD vehicle 52. In various embodiments, in addition to navigation subsystem 130, IVS 100 may further include a number of infotainment subsystems/applications, e.g., instrument cluster subsystem/applications, front-seat infotainment subsystem/application, such as, a navigation subsystem/application, a media subsystem/application, a vehicle status subsystem/application and so forth, and a number of rear seat entertainment subsystems/applications (not shown).

In various embodiments, IVS 100 and personal system 150, on their own or in response to user interactions, communicate or interact 54c with each other, as well as communicate or interact 54a-54b with one or more remote/cloud servers 60. In particular, in various embodiments, remote/cloud servers 60 include route logging and prediction service 180. Personal system 150 communicates 54b with route logging and prediction service 180 to provide the locations of the various routes/paths traveled by traveler (or moving object) 72 for various trips. Personal systems 150 also communicates 54b with route logging and prediction service 180 to receive its current intended or projected path, and broadcast 54c the current intended or projected path for vehicle 52. In alternate embodiments, IVS 100 may communicate 54a with route logging and prediction service 180 to receive the current intended or projected path of traveler (moving object) 72 instead.

In various embodiments, IVS 100 and personal system 150 communicate 54a-54b with server 60 via cellular communication, e.g., via a wireless signal repeater or base station on transmission tower 56 near vehicle 52 and personal system 150, and one or more private and/or public wired and/or wireless networks 58. Examples of private and/or public wired and/or wireless networks 58 may include the Internet, the network of a cellular service provider, and so forth. It is to be understood that transmission tower 56 may be different towers at different times/locations, as vehicle 52 travels enroute to its destination or personal system 150 moves around. In various embodiments, IVS 100 and personal system 150 communicate with each other directly via WiFi or dedicated short range communication (DSRC).

Except for the technology of the present disclosure provided, IVS 100 and CA/AD vehicle 52 otherwise may be any one of a number of IVS and CA/AD vehicles, from computer-assisted to partially or fully autonomous vehicles, known in the art. These and other aspects of IVS 100 will be further described with references to the remaining Figures. Before doing so, it should be noted that, while for ease of understanding, only one vehicle 52 and one traveler (or moving object) is shown, the present disclosure is not so limited. In practice, there may be multitude of vehicles 52 (IVS 100) and/or personal systems 150 of travelers equipped with the technology of the present disclosure.

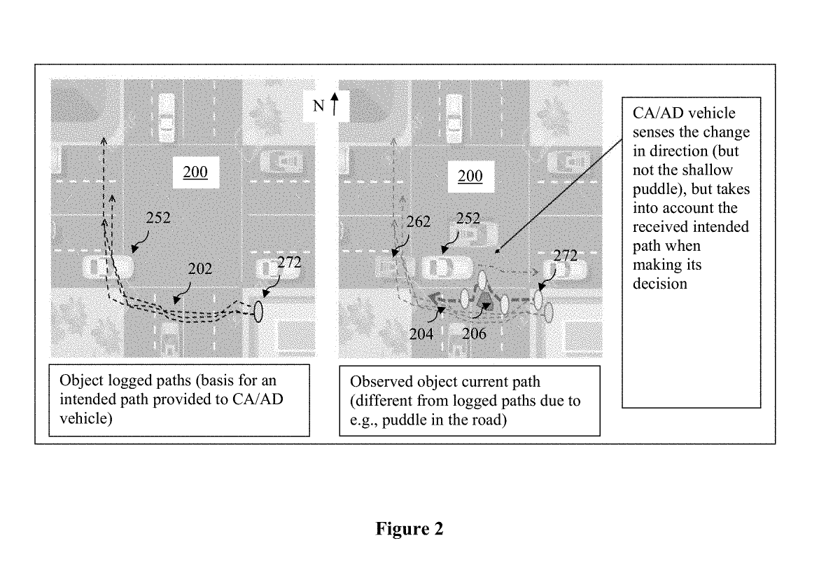

Referring now to FIG. 2, wherein an example application of the CA/AD technology with consideration of travelers' intent of the present disclosure, according to various embodiments, is illustrated. As shown in the left pane of FIG. 2, vehicle 252, which may be vehicle 52, is entering intersection 200, traveling in a west to east direction, on the rightmost curb lane. Shown also in the left pane of FIG. 2 is the fact that traveler (or moving object) 272, which may be traveler (or moving object) 72, had traveled through intersection 200 before on previous trips. More specifically, on previous trips, traveler (or moving object) 272 had first crossed the entirety of intersection 200 at the south end, traveling in an east to west direction, then crossed the entirety of intersection 200 at the west end, traveling in a south to north direction.

As illustrated in the right pane of FIG. 2, in a current trip, as traveler (or moving object) 272 crosses intersection 200 at the south end, traveling in an east to west direction, traveler (or moving object) 272 makes a right turn in the middle of the crossing, traveling for a moment in a south to north direction, to avoid an obstacle 206 (e.g., a shallow puddle) in the middle of the south end of intersection 200. The south to north travel by object 272, when observed by vehicle 252, would suggest a potential collision, if vehicle 252 failed to notice the shallow puddle and understand that the south to north travel is only for momentarily. Traveler (or moving object) 272 was not going to turn and start crossing intersection 200 in a south to north direction at that point. Under the prior art, without the correct understanding, in order to avoid hitting traveler (or moving object) 272, vehicle 252 would make evasive action, changing lane if possible, and if changing lane is not an option, vehicle 252 would make emergency braking to halt further forward progress of vehicle 252.

However, as also illustrated in the right pane of FIG. 2, under the present disclosure, the current intended or projected path 204 of traveler (or moving object) 272, generated based on logged routes/paths of past travels, indicates traveler (or moving object) 272 intends or projected to continue its travel in an east to west direction. When provided with this information, the intended or projected path 204 of traveler (or moving object) 272, vehicle 252 may moderate its response to the observance of traveler (or moving object) 272 brief travel in the south to north direction at the middle of the south end of intersection 200. Vehicle 252 may decelerate, slightly slow down to provide time to ensure traveler (or moving object) 272 indeed turn left and continue on the east to west direction, as opposed to making sudden lane change or applying emergency braking. Such a moderate move may be safer, as it reduces the likelihood of vehicle 262 rear ending vehicle 252 (or vehicle 252 side swiping another vehicle in the adjacent lane).

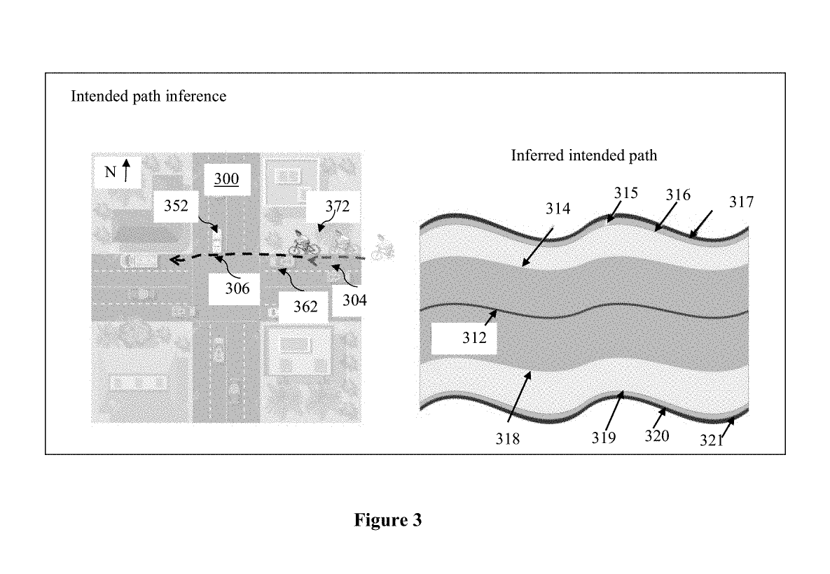

Referring now to FIG. 3, wherein the inference or projection of a current intended or projected path of a traveler, with further details, according to various embodiments, is illustrated. As shown, as traveler (or moving object) 372 (which may be bicyclist 72 of FIG. 1) travels along its current path, and about to enter intersection 300 at the north end, in an east to west direction, its current intended or projected path 306 can be generated based on the logged paths through the intersection in its past travels, and provided to vehicles 352 and 362 (which may be vehicle 52 of FIG. 1), as earlier described.

The right hand side of FIG. 3 illustrates intended or projected path 306 of traveler (or moving object) 372 provided to vehicles 352 and 362 in further details, in accordance with some embodiments. As shown, the intended or projected path 306 of object 372 is described with an expected path 312 bounded by threshold/confidence boundaries 314-321 on a first side and a second side opposite to the first side. More specifically, for the illustrated embodiments, the expected path 312 is a statistical mean path, and the threshold/confidence boundaries include a probabilistic plus one standard deviation boundary 314, a probabilistic plus two standard deviation boundary 315, a probabilistic plus three standard deviation boundary 316 and a probabilistic plus four standard deviation boundary 317 on the first side, and a probabilistic minus one standard deviation boundary 318, a probabilistic minus two standard deviation boundary 319, a probabilistic minus three standard deviation boundary 320, and a probabilistic minus four standard deviation boundary 321 on the second side. In alternate embodiments, the intended or projected path 306 may be described in other manner.

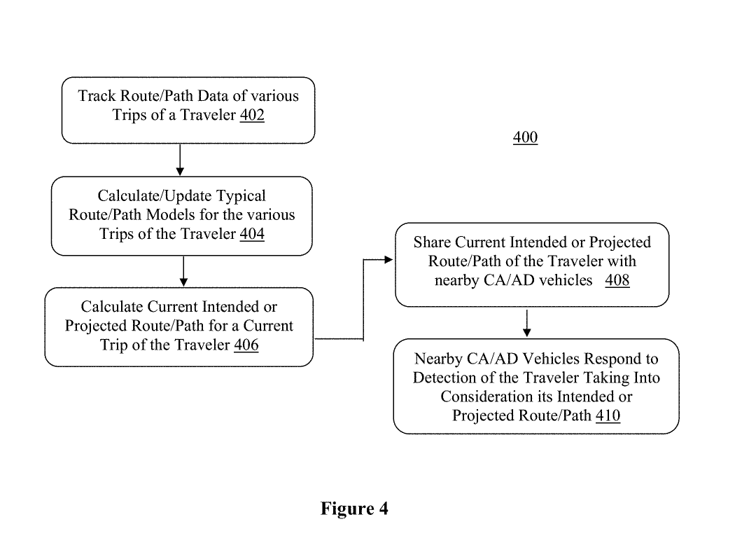

Referring now to FIG. 4, wherein an example process of CA/AD with consideration of travelers' intent of the present disclosure, according to various embodiments, is illustrated. As shown, for the illustrated embodiments, process 400 for CA/AD with consideration of travelers' intent includes operations performed at block 402-408. In various embodiments, the operations at block 402-408 are performed by a personal system of a traveler, a cloud server or service, and an IVS of a CA/AD vehicle.

As shown, process 400 starts at block 402. At block 402, route/path data of various trips of a traveler are tracked and logged. In various embodiments, as described earlier, the route/path data of various trips of a traveler may be tracked with a personal system worn or carried by the traveler, and reported to a cloud service/server for storage.

Next, at block 404, the typical route/path models for these trips may be calculated based on the logged/reported route/path data. In various embodiments, the route/path models of the various trips may be calculated by a route/path logging and prediction cloud service of a cloud server.

At block 406, a current intended or projected route/path for a current location of a current trip of the traveler is calculated, using a calculated typical route/path model that covers the current trip. In various embodiments, the calculation may take into consideration of the current time at a first location, the historic time to travel from the first location to a second location and the current speed of the traveler. In various embodiments, the intended or projected route/path of the current trip may be calculated by the route/path logging and prediction cloud service of the cloud server.

At block 408, the current intended or projected route/path for the current location of the current trip of the traveler is shared with the nearby CA/AD vehicles. In various embodiments, the current intended or projected route/path for the current trip of the traveler may be shared with the nearby CA/AD vehicles by the cloud service/server directly (with the CA/AD subscribing to the service of the cloud server), or via the personal system of the traveler (with the cloud service/server returning the current intended or projected route/path for the current trip of the traveler to the personal system of the traveler).

At block 410, response to the detection or observance of the traveler is determined, factoring into consideration the received current intended or projected route/path for the current trip of the traveler. For example, a no response may be determined if the traveler is detected or observed within certain threshold or confidence boundaries, and the response might be progressive relative to the degree the traveler is detected or observed outside certain threshold or confidence boundaries. In various embodiments, the response to the detection or observance of the traveler may be determined by the navigation subsystem of the CA/AD vehicle detecting or observing the traveler.

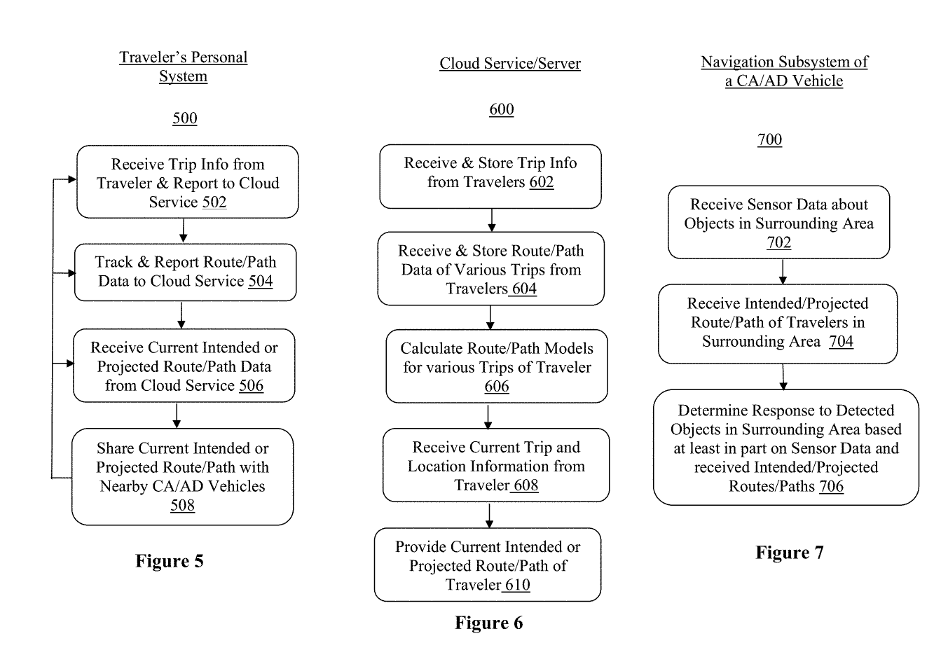

These operations are further described below with references to FIGS. 5-7.

Referring now FIG. 5, wherein an example process of a personal system of a traveler, according to various embodiments, is illustrated. As shown, for the illustrated embodiments, process 500 for a personal system of a traveler includes operations performed at block 502-508. In various embodiments, the operations at block 502-508 may be performed by a route/path logger/reporter of a personal system of a traveler.

Process 500 starts at block 502. At block 502, information about a trip of the traveler (e.g., a starting location, a destination, time & date) are received. The received trip information is in turn reported to a cloud service/server for storage. The trip information may be received from the traveler. The received trip information may be reported to the cloud service/server via wireless cellular communication.

Next, at block 504, route/path data of the trip are collected. The route/path data of the trip may be collected from various sensors, such as GPS sensors, included with the personal system of the traveler. The route/path data of the trip may be collected from the various sensors continuously or periodically. The periodicity may depend on the traveling speed or the type of travelers, e.g., a slow pedestrian, a pedestrian walking at a moderate or fast pace, a jogger, a slow bicyclist, a bicyclist cycling at moderate or high speed, and so forth. In embodiments, the periodicity may depend on whether the environmental condition is likely to induce fast or slow pace travel, such as, whether the terrain is smooth or rough, whether it is a sunny or rainy day, and so forth.

In various embodiments, as described earlier, the collected route/path data are reported to a route logging and prediction cloud service of a cloud server for logging and storage. The collected route/path data may be similarly reported to the cloud service/server via wireless cellular communication. The collected route/path data may be reported continuously as they are collected, or in batch.

Next at block 506, at a later current trip traveling over routes/paths the traveler had previously traveled with route/path data collected, a current intended or projected route/path for a current location of a current trip is received. In various embodiments, as described earlier, the current intended or projected route/path for the current location of the current trip may be received from the cloud service/server. In various embodiments, the current intended or projected route/path for the current location of the current trip may be received from the cloud service/server continuously. In other embodiments, the current intended or projected route/path for the current location of the current trip may be received from the cloud service/server at selected locations of interest, e.g., an intersection where the traveler may collide with a CA/AD vehicle.

At block 508, the current intended or projected route/path for a current location of a current trip is shared with nearby CA/AD vehicles. In various embodiments, as described earlier, the current intended or projected route/path for the current location of the current trip may be broadcast via WiFi or dedicated short range communication. In various embodiments, the current intended or projected route/path for the current location of the current trip may be broadcast continuously. In other embodiments, the current intended or projected route/path for the current location of the current trip may be broadcast at selected locations of interest, e.g., an intersection where the traveler may collide with a CA/AD vehicle.

In alternate embodiments, at block 504, in lieu of reporting the collected route/path data of various trips to a cloud server/service, the collected route/path data of various trips may be stored in persistent storage of the personal system, if the personal system has sufficient persistent storage to store the volume of data and computing capacity to compute the intended or projected path of the traveler. The personal system may have sufficient storage or computing capacity by virtue of a large amount of storage and computing capacity provided, or by virtue of the fact that the personal system is designed to be used by a traveler with limited amount of travel (such as a robot with a mission that requires only limited amount of travel). For these embodiments, at block 506, in lieu of receiving the current intended or projected route/path, the current intended or projected route/path may be locally calculated by the personal system.

Referring now to FIG. 6, wherein an example process of a route logging and prediction cloud service, according to various embodiments, is illustrated. As shown, for the illustrated embodiments, process 600 for a route logging and prediction cloud service includes operations performed at block 602-610. In various embodiments, the operations at block 602-608 may be performed by a route/path logger/reporter and prediction engine of a cloud service/server.

Process 600 starts at block 602. At block 602, information about a trip of the traveler (e.g., a starting location, a destination, time & date) are received from a personal system of a traveler, and stored. The received trip information may be reported to the cloud service/server via wireless cellular communication.

Next, at block 604, route/path data of the trip are received from the personal system, as they are collected or in batch, and stored. In various embodiments, as described earlier, the collected route/path data are received via wireless cellular communication.

Next at block 606, route/path models of the trip of the traveler are calculated/updated, based on the route/path data received. As described, in various embodiments, the calculation includes the calculations of an expected path bounded by threshold/confidence boundaries on a first side and a second side opposite to the first side. More specifically, in various embodiments, the calculation includes the calculations of a statistical mean path, and the various probabilistic standard deviation boundaries on both sides of the statistical mean path, the probabilistic plus one standard deviation boundary, the probabilistic plus two standard deviation boundary, the probabilistic plus three standard deviation boundary, and the probabilistic plus four standard deviation boundary 317 on the first side, and the probabilistic minus one standard deviation boundary, the probabilistic minus two standard deviation boundary, the probabilistic minus three standard deviation boundary, and the probabilistic minus four standard deviation boundary on the second side. In alternate embodiments, the calculation may include calculations of other types of confidence measures.

At block 608, a current location of a current trip of the traveler is received. And in response, at block 610, a current intended or projected path of the traveler at the current location is determined using the calculated route/path models of the past trips. In various embodiments, the calculation may take into consideration of the current time at a first location, the historic time to travel from the first location to a second location and the current speed of the traveler. The determined current intended or projected path of the traveler at the current location is provided for CA/AD vehicles near the traveler to factor into consideration in determining their response to the detection or observance of the traveler.

In various embodiments, as described earlier, the current intended or projected route/path for the current location of the current trip is returned to the personal system of the traveler to broadcast for the nearby CA/AD vehicles. In other embodiments, where the cloud server/service accepts subscription of CA/AD vehicles and the subscribing CA/AD vehicles report their current locations, the current intended or projected path of the traveler at the current location may be provided from the cloud service/server to a subscribing CA/AD vehicle directly, based on the location information of the traveler and the CA/AD vehicle.

Referring now to FIG. 7, wherein an example process of a navigation subsystem of a CA/AD vehicle, according to various embodiments. As shown, for the illustrated embodiments, process 700 for a navigation subsystem of a CA/AD vehicle includes operations performed at block 702-706. In various embodiments, the operations at block 702-706 may be performed by a navigation subsystem of a CA/AD vehicle.

Process 700 starts at block 702. At block 702, sensor data about objects in a current surrounding area of a CA/AD vehicle are received. As described earlier, the sensor data may include sensor data of moving objects near the CA/AD vehicle or stationary objects. Sensor data may include sensor data collected by LiDAR, cameras, motion detectors, and so forth. The size of the surrounding area may vary from application to application, depending on the sensing capability or range of the sensors included with the CA/AD vehicle.

At block 704, intended or projected paths of nearby travelers are received. As described earlier, the intended or projected paths may be received via broadcasting by the nearby travelers or from a cloud service/server to which the CA/AD vehicle subscribes for the service.

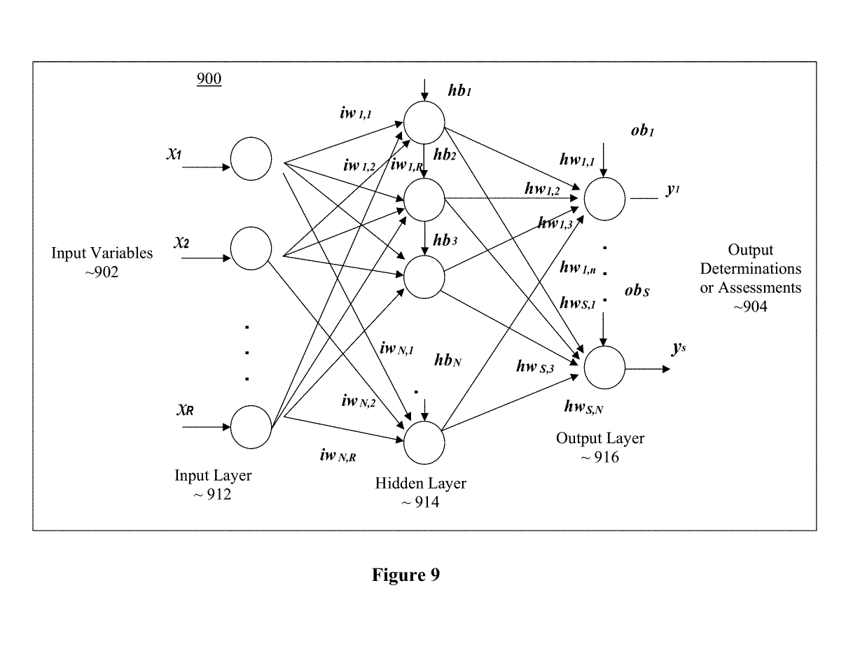

At block 706, a determination to respond to the detection or observance of the nearby travelers are made. As described earlier, the navigation subsystem of the CA/AD vehicle may be provided with machine learning trained to make the determination factoring into consideration the intended or projected paths of the nearby travelers received. For example, a no response may be determined if the traveler is detected or observed within certain threshold or confidence boundaries, and the response might be progressive relative to the degree the traveler is detected or observed outside certain threshold or confidence boundaries. In various embodiments, operations at 706 may also include providing feedback to the navigation subsystem with machine learning. An example neural network used by the navigation subsystem will be further described below with references to FIG. 9.

Referring now to FIG. 8, a component view of an example personal system, according to various embodiments, is shown. As illustrated, personal system 800 includes processor 802, memory 804, sensors 806 and communication interface 808. Processor 802 may be any one of a number of single or multi-core processors known in the art. Memory 804 may similarly be any one of a number of random-access memory known in art. Memory 804 includes in particular route/path tracking and report module/engine 810 (which may be route logger/reporter 170 of FIG. 1) configured to perform the route/path data tracking and reporting operations earlier described. Sensors may include various sensors known in the art, in particular, GPS sensors. Communication interface 808 may include cellular communication circuitry as well as WiFi or dedicated short range communication circuitry.

In various embodiments, personal system 800 may be configured to store the route/path data of various trips collected, and locally determine the current intended or projected path for a current location of a current trip. For these embodiments, personal system 800 may further include persistent storage 812 to store the route/path data collected, as well as the route path models constructed. Memory 804 may include a route/path predictor 816 to construct the route/path models for various trips, as well as to infer or project an intended or projected path of a current location of a current trip, as earlier described. Except for its usage, persistent storage 812 may similarly be any one of a number of persistent storage devices known in the art.

In various embodiments, personal system 800 may be a smart watch, a portable or wearable device having one or more applications (not shown), such as a health related application, a news application, a calendar application, a messaging application and so forth

Referring now to FIG. 9, wherein an example neural network suitable for use to determine a response to a detected/observed traveler, in accordance with various embodiments, is shown. Example neural network 900 may be suitable for use by navigation subsystem 130 of FIG. 1. As shown, example neural network 900 may be a multilayer feedforward neural network (FNN) comprising an input layer 912, one or more hidden layers 914 and an output layer 916. Input layer 912 receives data of input variables (xᵢ) 902. Hidden layer(s) 914 processes the inputs, and eventually, output layer 916 outputs the determinations or assessments (yᵢ) 904. In one example implementation the input variables (xᵢ) 902 of the neural network are set as a vector containing the relevant variable data, while the output determination or assessment (yᵢ) 904 of the neural network are also as a vector.

Multilayer feedforward neural network (FNN) may be expressed through the following equations:

hoᵢ=f(Σ_{f=1}^{R}(iw_{i,j}xⱼ)+hbᵢ), for i=1, . . . ,N

yᵢ=f(Σₖ₌₁^{N}(hw_{i,k}hoₖ)+obᵢ), for i=1, . . . ,S

where hoᵢ and yᵢ are the hidden layer variables and the final outputs, respectively. f( ) is typically a non-linear function, such as the sigmoid function or rectified linear (ReLu) function that mimics the neurons of the human brain. R is the number of inputs. N is the size of the hidden layer, or the number of neurons. S is the number of the outputs.

The goal of the FNN is to minimize an error function E between the network outputs and the desired targets, by adapting the network variables iw, hw, hb, and ob, via training, as follows:

E=Σₖ₌₁^{m}(Eₖ), where Eₖ=Σₚ₌₁^{S}(tₖₚ−yₖₚ)²

where yₖₚ and tₖₚ are the predicted and the target values of pth output unit for sample k, respectively, and m is the number of samples.

For navigation subsystem 130, input variables (xᵢ) 902 may include various sensor data collected by various vehicles sensors, as well as data describing the intended or projected paths of nearby travelers. The output variables (yᵢ) 904 may include the determined response, adjusting speed, braking, changing lane, and so forth. The network variables of the hidden layer(s) for the neural network of X, are determined by the training data.

In the example of FIG. 9, for simplicity of illustration, there is only one hidden layer in the neural network. In some other embodiments, there can be many hidden layers. Furthermore, the neural network can be in some other types of topology, such as Convolution Neural Network (CNN), Recurrent Neural Network (RNN), and so forth.

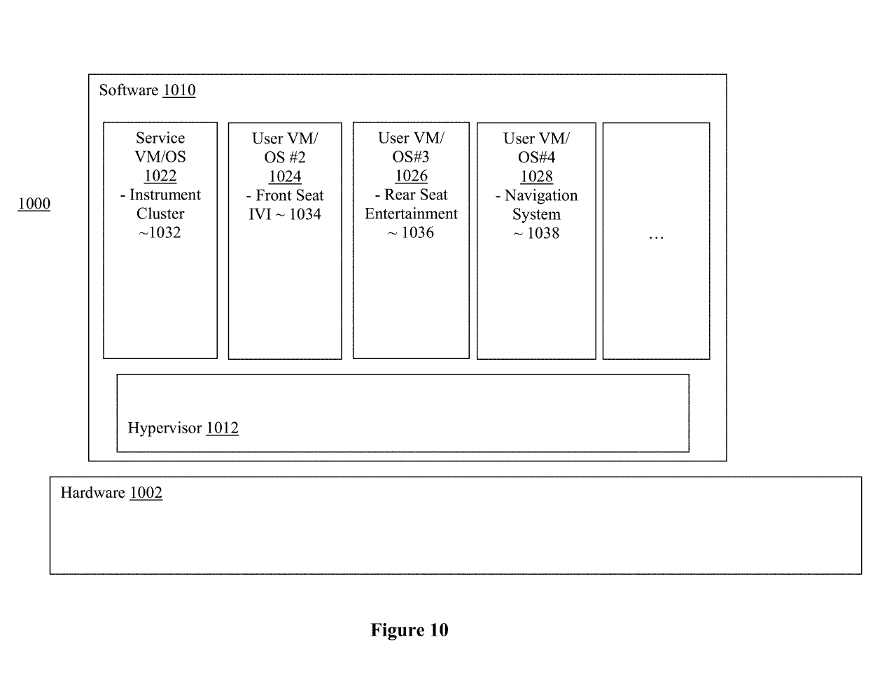

Referring now to FIG. 10, wherein a software component view of the in vehicle system, according to various embodiments, is illustrated. As shown, for the embodiments, IVS system 1000, which could be IVS system 100, includes hardware 1002 and software 1010. Software 1010 includes hypervisor 1012 hosting a number of virtual machines (VMs) 1022-1028. Hypervisor 1012 is configured to host execution of VMs 1022-1028. The VMs 1022-1028 include a service VM 1022 and a number of user VMs 1024-1028. Service machine 1022 includes a service OS hosting execution of a number of instrument cluster applications 1032. User VMs 1024-1028 may include a first user VM 1024 having a first user OS hosting execution of front seat infotainment applications 1034, a second user VM 1026 having a second user OS hosting execution of rear seat infotainment applications 1036, a third user VM 1028 having a third user OS hosting execution of navigation subsystem 1038, incorporated with the travelers intent technology, and so forth.

Except for the travelers intent technology of the present disclosure incorporated, elements 1012-1038 of software 1010 may be any one of a number of these elements known in the art. For example, hypervisor 1012 may be any one of a number of hypervisors known in the art, such as KVM, an open source hypervisor, Xen, available from Citrix Inc, of Fort Lauderdale, Fla., or VMware, available from VMware Inc of Palo Alto, Calif., and so forth. Similarly, service OS of service VM 1022 and user OS of user VMs 1024-1028 may be any one of a number of OS known in the art, such as Linux, available e.g., from Red Hat Enterprise of Raleigh, N.C., or Android, available from Google of Mountain View, Calif.

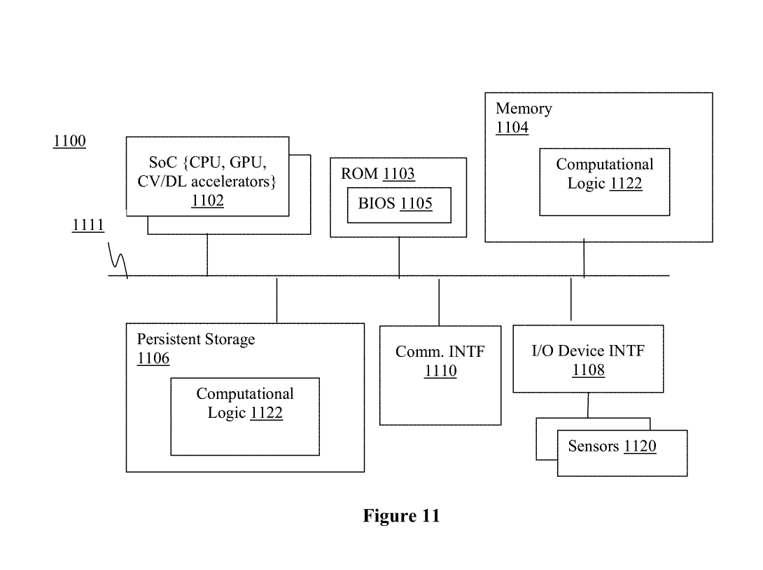

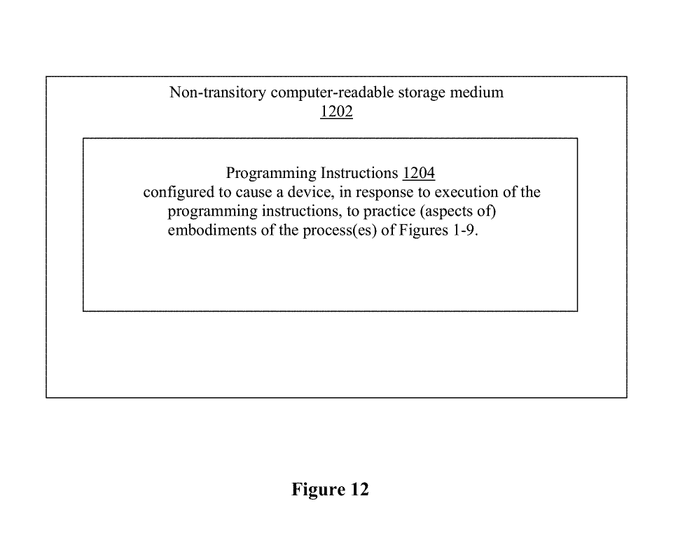

Referring now to FIG. 11, wherein an example computing platform that may be suitable for use to practice the present disclosure, according to various embodiments, is illustrated. As shown, computing platform 1100, which may be hardware 1002 of FIG. 10, or a computing platform of one of the servers 60 of FIG. 1, include one or more system-on-chips (SoCs) 1102, ROM 1103 and system memory 1104. Each SoCs 1102 may include one or more processor cores (CPUs), one or more graphics processor units (GPUs), one or more accelerators, such as computer vision (CV) and/or deep learning (DL) accelerators. ROM 1103 may include basic input/output system services (BIOS) 1105. CPUs, GPUs, and CV/DL accelerators may be any one of a number of these elements known in the art. Similarly, ROM 1103 and BIOS 1105 may be any one of a number of ROM and BIOS known in the art, and system memory 1104 may be any one of a number of volatile storage devices known in the art.

Additionally, computing platform 1100 may include persistent storage devices 1106. Example of persistent storage devices 1106 may include, but are not limited to, flash drives, hard drives, compact disc read-only memory (CD-ROM) and so forth. Further, computing platform 1100 may include one or more input/output (I/O) interfaces 1108 to interface with one or more I/O devices, such as sensors 1120. Other example I/O devices may include, but are not limited to, display, keyboard, cursor control and so forth. Computing platform 1100 may also include one or more communication interfaces 1110 (such as network interface cards, modems and so forth). Communication devices may include any number of communication and I/O devices known in the art. Examples of communication devices may include, but are not limited to, networking interfaces for Bluetooth®, Near Field Communication (NFC), WiFi, Cellular communication (such as LTE 4G/5G) and so forth. The elements may be coupled to each other via system bus 1111, which may represent one or more buses. In the case of multiple buses, they may be bridged by one or more bus bridges (not shown).

Each of these elements may perform its conventional functions known in the art. In particular, ROM 1103 may include BIOS 1105 having a boot loader. System memory 1104 and mass storage devices 1106 may be employed to store a working copy and a permanent copy of the programming instructions implementing the operations associated with hypervisor 112, service/user OS of service/user VM 1022-1028, components of navigation subsystem 1038, or a traveler intended or projected path cloud service of server 60, collectively referred to as computational logic 922. The various elements may be implemented by assembler instructions supported by processor core(s) of SoCs 1102 or high-level languages, such as, for example, C, that can be compiled into such instructions.

As will be appreciated by one skilled in the art, the present disclosure may be embodied as methods or computer program products. Accordingly, the present disclosure, in addition to being embodied in hardware as earlier described, may take the form of an entirely software embodiment (including firmware, resident software, micro-code, etc.) or an embodiment combining software and hardware aspects that may all generally be referred to as a “circuit,” “module” or “system.” Furthermore, the present disclosure may take the form of a computer program product embodied in any tangible or non-transitory medium of expression having computer-usable program code embodied in the medium. FIG. 12 illustrates an example computer-readable non-transitory storage medium that may be suitable for use to store instructions that cause an apparatus, in response to execution of the instructions by the apparatus, to practice selected aspects of the present disclosure described with references to FIGS. 1-8. As shown, non-transitory computer-readable storage medium 1202 may include a number of programming instructions 1204. Programming instructions 1204 may be configured to enable a device, e.g., computing platform 1100, in response to execution of the programming instructions, to implement (aspects of) hypervisor 112, service/user OS of service/user VM 122-128, components of navigation subsystem 1038, or a traveler intended or projected path cloud service of server 60. In alternate embodiments, programming instructions 1204 may be disposed on multiple computer-readable non-transitory storage media 1202 instead. In still other embodiments, programming instructions 1204 may be disposed on computer-readable transitory storage media 1202, such as, signals.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a,” “an” and “the” are intended to include plural forms as well, unless the context clearly indicates otherwise. It will be further understood that the terms “comprises” and/or “comprising,” when used in this specification, specific the presence of stated features, integers, steps, operations, elements, and/or components, but do not preclude the presence or addition of one or more other features, integers, steps, operation, elements, components, and/or groups thereof.

Embodiments may be implemented as a computer process, a computing system or as an article of manufacture such as a computer program product of computer readable media. The computer program product may be a computer storage medium readable by a computer system and encoding a computer program instructions for executing a computer process.

The corresponding structures, material, acts, and equivalents of all means or steps plus function elements in the claims below are intended to include any structure, material or act for performing the function in combination with other claimed elements are specifically claimed. The description of the present disclosure has been presented for purposes of illustration and description, but is not intended to be exhaustive or limited to the disclosure in the form disclosed. Many modifications and variations will be apparent to those of ordinary skill without departing from the scope and spirit of the disclosure. The embodiment was chosen and described in order to best explain the principles of the disclosure and the practical application, and to enable others of ordinary skill in the art to understand the disclosure for embodiments with various modifications as are suited to the particular use contemplated.

Thus various example embodiments of the present disclosure have been described including, but are not limited to:

Example 1 is an apparatus for computer-assisted or autonomous driving (CA/AD), comprising: one or more communication interfaces, disposed in a CA/AD vehicle, to receive an intended or projected path of a traveler proximally traveling near the CA/AD vehicle; sensors, disposed in the CA/AD vehicle, to collect sensor data associated with stationary or moving objects in a surrounding area of the CA/AD vehicle, including the traveler proximally traveling near the CA/AD vehicle; and a navigation subsystem, disposed in the CA/AD vehicle and coupled with the one or more communication interfaces and the sensors, to navigate or assist in navigating the CA/AD vehicle to a destination, based at least in part on the sensor data associated with the stationary or moving objects in the surrounding area, and the received intended or projected path of the traveler proximally traveling near the CA/AD vehicle.

Example 2 is example 1, wherein the traveler proximally traveling near the CA/AD vehicle is a selected one of a pedestrian or a bicyclist.

Example 3 is example 1, wherein the one or more communication interfaces include a selected one of a WiFi interface or a dedicated short range communication interface, to receive the intended or projected path of the traveler proximally traveling near the CA/AD vehicle from a personal system of the traveler.

Example 4 is example 1, wherein the one or more communication interfaces include a cellular communication interface to receive the intended or projected path of the traveler proximally traveling near the CA/AD vehicle from a cloud server.

Example 5 is example 1, wherein the intended or projected path of the traveler proximally traveling near the CA/AD vehicle comprises an expected path bounded by threshold or confidence boundaries on a first side and a second side opposite to the first side.

Example 6 is example 5, wherein the expected path is a statistical mean path, and the threshold or confidence boundaries include a probabilistic plus one standard deviation boundary on the first side, and a probabilistic minus one standard deviation boundary on the second side.

Example 7 is example 1, wherein the sensors include one or more global positioning sensors, light detection and ranging sensors, motion sensors or cameras.

Example 8 is example 1, wherein the navigation subsystem is provided with machine learning, and trained to determine a response to the movement of the object, based at least in part on the sensor data associated with the stationary or moving objects in the surrounding area, and the received intended or projected path of the traveler.

Example 9 is example 8, wherein the navigation subsystem is trained to moderate a response to the movement of the object in accordance with the sensor data associated with the stationary or moving objects in the surrounding area, in view of the received intended or projected path of the traveler suggesting non-collision with the object, including threshold or confidence boundaries of the intended or projected path.

Example 10 is example 8, wherein the navigation subsystem is trained to moderate, halt, or reverse movement of the CA/AD vehicle, in view of the received intended or projected path of the traveler suggesting potential collision with the traveler, regardless of whether the sensor data associated with the stationary or moving objects in the surrounding area suggesting potential collision with the traveler.

Example 11 is an apparatus for a traveler, comprising: sensors to collect sensor data associated with routes or paths traveled by the traveler, while carrying or wearing the apparatus; and one or more communication interfaces to provide an intended or projected path of the traveler to a vehicle proximately moving near the traveler, the intended or projected path being inferred or projected based at least in part on the sensor data collected for routes or paths previously traveled by the traveler.

Example 12 is example 11, wherein the sensors comprise a global positioning sensor.

Example 13 is example 11, wherein the one or more communication interfaces comprise a WiFi interface or a dedicated short range communication interface, to provide the intended or projected path of the traveler to the vehicle proximally moving near the traveler.

Example 14 is example 11, wherein the one or more communication interfaces are arranged to further provide the sensor data collected for routes or paths traveled by the traveler, to a cloud server.

Example 15 is example 11, wherein the one or more communication interfaces comprise a cellular communication interface, to provide the sensor data collected for routes or paths traveled by the traveler, to the cloud server.

Example 16 is example 11, wherein the one or more communication interfaces are further arranged to receive the intended or projected path of the traveler from the cloud server.

Example 17 is example 11, further comprising a data storage to store the sensor data collected for routes or paths previously traveled by the traveler; an intended or project path prediction engine; and a processor, coupled to the data storage, to operate the intended or project path prediction engine to generate the intended or project path of the traveler.

Example 18 is at least one computer-readable medium (CRM) having instructions stored therein, to cause a computing device, in response to execution of the instruction by the computing device, to: receive, from a personal system of a pedestrian or a bicyclist, sensor data collected by sensors of the personal system for routes or paths traveled by the pedestrian or a bicyclist; store the received sensor data collected for routes or paths traveled by the pedestrian or a bicyclist; generate a current intended or projected path of the pedestrian or a bicyclist, based at least in part on the stored sensor data for routes or paths previously traveled by the pedestrian or a bicyclist; and output the generated current intended or projected path of the pedestrian or a bicyclist to assist a computer assisted or autonomous driving (CA/AD) vehicle in responding to detection of the pedestrian or a bicyclist proximally traveling near the CA/AD vehicle.

Example 19 is example 18, wherein to generate a current intended or projected path of the pedestrian or a bicyclist comprises to generate an expected path bounded by threshold or confidence boundaries on a first side and a second side opposite to the first side, including a current time at a first location, a historic time to travel from a the first location to a second location and a current speed.

Example 20 is example 19, wherein the expected path is a statistical mean path, and the threshold or confidence boundaries include a probabilistic plus one standard deviation boundary on the first side, and a probabilistic minus one standard deviation boundary on the second side.

Example 21 is example 18, wherein to output the generated current intended or projected path of the pedestrian or a bicyclist comprises to transmit the generated current intended or projected path of the pedestrian or a bicyclist to the personal system of the pedestrian or a bicyclist.

Example 22 is example 18, wherein to output the generated current intended or projected path of the pedestrian or bicyclist comprises to transmit the generated current intended or projected path of the pedestrian or a bicyclist to a navigation subsystem of the CA/AD vehicle.

Example 23 is a method for computer assisted or autonomous driving (CA/AD), comprising: assisting or autonomously navigating a vehicle to a destination; detecting an object proximally moving near the vehicle; and determining a response to the detection of the object proximally moving near the vehicle, based at least in part on a received intended or projected path of the object.

Example 24 is example 23, wherein determining a response comprising moderating a response to the movement of the object in accordance with sensor data associated with stationary or moving objects in the surrounding area, in view of the received intended or projected path of the object suggesting non-collision with the object, including threshold or confidence boundaries of the intended or projected path.

Example 25 is example 23, wherein determining a response comprising moderating, halting, or reversing movement of the vehicle, in view of the received intended or projected path of the object suggesting potential collision with the object, regardless of whether sensor data associated with stationary or moving objects in the surrounding area suggesting potential collision with the object.

It will be apparent to those skilled in the art that various modifications and variations can be made in the disclosed embodiments of the disclosed device and associated methods without departing from the spirit or scope of the disclosure. Thus, it is intended that the present disclosure covers the modifications and variations of the embodiments disclosed above provided that the modifications and variations come within the scope of any claims and their equivalents.

What is claimed is:

1. An apparatus for computer-assisted or autonomous driving (CA/AD), comprising:
one or more communication interfaces, disposed in a CA/AD vehicle, to receive an intended or projected path of a traveler proximally traveling near the CA/AD vehicle;
sensors, disposed in the CA/AD vehicle, to collect sensor data associated with stationary or moving objects in a surrounding area of the CA/AD vehicle, including the traveler proximally traveling near the CA/AD vehicle; and
a navigation subsystem, disposed in the CA/AD vehicle and coupled with the one or more communication interfaces and the sensors, to navigate or assist in navigating the CA/AD vehicle to a destination, based at least in part on the sensor data associated with the stationary or moving objects in the surrounding area, and the received intended or projected path of the traveler proximally traveling near the CA/AD vehicle.

2. The apparatus of claim 1, wherein the traveler proximally traveling near the CA/AD vehicle is a selected one of a pedestrian or a bicyclist.

3. The apparatus of claim 1, wherein the one or more communication interfaces include a selected one of a WiFi interface or a dedicated short range communication interface, to receive the intended or projected path of the traveler proximally traveling near the CA/AD vehicle from a personal system of the traveler.

4. The apparatus of claim 1, wherein the one or more communication interfaces include a cellular communication interface to receive the intended or projected path of the traveler proximally traveling near the CA/AD vehicle from a cloud server.

5. The apparatus of claim 1, wherein the intended or projected path of the traveler proximally traveling near the CA/AD vehicle comprises an expected path bounded by threshold or confidence boundaries on a first side and a second side opposite to the first side.

6. The apparatus of claim 5, wherein the expected path is a statistical mean path, and the threshold or confidence boundaries include a probabilistic plus one standard deviation boundary on the first side, and a probabilistic minus one standard deviation boundary on the second side.

7. The apparatus of claim 1, wherein the sensors include one or more global positioning sensors, light detection and ranging sensors, motion sensors or cameras.

8. The apparatus of claim 1, wherein the navigation subsystem is provided with machine learning, and trained to determine a response to the movement of the objects, based at least in part on the sensor data associated with the stationary or moving objects in the surrounding area, and the received intended or projected path of the traveler.

9. The apparatus of claim 8, wherein the navigation subsystem is trained to moderate a response to the movement of the object in accordance with the sensor data associated with the stationary or moving objects in the surrounding area, in view of the received intended or projected path of the traveler suggesting non-collision with the object, including threshold or confidence boundaries of the intended or projected path.

10. The apparatus of claim 8, wherein the navigation subsystem is trained to moderate, halt, or reverse movement of the CA/AD vehicle, in view of the received intended or projected path of the traveler suggesting potential collision with the traveler, regardless of whether the sensor data associated with the stationary or moving objects in the surrounding area suggesting potential collision with the traveler.

11. An apparatus for a traveler, comprising:
sensors to collect sensor data associated with routes or paths traveled by the traveler, while carrying or wearing the apparatus; and
one or more communication interfaces to provide an intended or projected path of the traveler to a vehicle proximately moving near the traveler, the intended or projected path being inferred or projected based at least in part on the sensor data collected for routes or paths previously traveled by the traveler.

12. The apparatus of claim 11, wherein the sensors comprise a global positioning sensor.

13. The apparatus of claim 11, wherein the one or more communication interfaces comprise a WiFi interface or a dedicated short range communication interface, to provide the intended or projected path of the traveler to the vehicle proximally moving near the traveler.

14. The apparatus of claim 11, wherein the one or more communication interfaces are arranged to further provide the sensor data collected for routes or paths traveled by the traveler, to a cloud server.

15. The apparatus of claim 11, wherein the one or more communication interfaces comprise a cellular communication interface, to provide the sensor data collected for routes or paths traveled by the traveler, to the cloud server.

16. The apparatus of claim 11, wherein the one or more communication interfaces are further arranged to receive the intended or projected path of the traveler from the cloud server.

17. The apparatus of claim 11, further comprising a data storage to store the sensor data collected for routes or paths previously traveled by the traveler; an intended or project path prediction engine; and a processor, coupled to the data storage, to operate the intended or project path prediction engine to generate the intended or project path of the traveler.

18. At least one computer-readable medium (CRM) having instructions stored therein, to cause a computing device, in response to execution of the instruction by the computing device, to:
receive, from a personal system of a pedestrian or a bicyclist, sensor data collected by sensors of the personal system for routes or paths traveled by the pedestrian or a bicyclist;
store the received sensor data collected for routes or paths traveled by the pedestrian or a bicyclist;
generate a current intended or projected path of the pedestrian or a bicyclist, based at least in part on the stored sensor data for routes or paths previously traveled by the pedestrian or a bicyclist; and
output the generated current intended or projected path of the pedestrian or a bicyclist to assist a computer assisted or autonomous driving (CA/AD) vehicle in responding to detection of the pedestrian or a bicyclist proximally traveling near the CA/AD vehicle.

19. The CRM of claim 18, wherein to generate a current intended or projected path of the pedestrian or a bicyclist comprises to generate an expected path bounded by threshold or confidence boundaries on a first side and a second side opposite to the first side, including a current time at a first location, a historic time to travel from a first location to a second location and a current speed.

20. The CRM of claim 19, wherein the expected path is a statistical mean path, and the threshold or confidence boundaries include a probabilistic plus one standard deviation boundary on the first side, and a probabilistic minus one standard deviation boundary on the second side.

21. The CRM of claim 18, wherein to output the generated current intended or projected path of the pedestrian or a bicyclist comprises to transmit the generated current intended or projected path of the pedestrian or a bicyclist to the personal system of the pedestrian or a bicyclist.

22. The CRM of claim 18, wherein to output the generated current intended or projected path of the pedestrian or bicyclist comprises to transmit the generated current intended or projected path of the pedestrian or a bicyclist to a navigation subsystem of the CA/AD vehicle.

23. A method for computer assisted or autonomous driving (CA/AD), comprising:
assisting or autonomously navigating a vehicle to a destination;
detecting an object proximally moving near the vehicle; and
determining a response to the detection of the object proximally moving near the vehicle, based at least in part on a received intended or projected path of the object.

24. The method of claim 23, wherein determining a response comprises moderating a response to the movement of the object in accordance with sensor data associated with stationary or moving objects in the surrounding area, in view of the received intended or projected path of the object suggesting non-collision with the object, including threshold or confidence boundaries of the intended or projected path.

25. The method of claim 23, wherein determining a response comprises moderating, halting, or reversing movement of the vehicle, in view of the received intended or projected path of the object suggesting potential collision with the object, regardless of whether sensor data associated with stationary or moving objects in the surrounding area suggesting potential collision with the object.
